(19) United States
(12) Patent Application Publication
(10) Pub. No.: US 2024/0091739 A1
(43) Pub. Date: Mar. 21, 2024

(54) MERCAPTO GROUP-LOADED LAYERED DOUBLE HYDROXIDE-BASED MAGNETIC COMPOSITE PARTICLE, AND PREPARATION METHOD AND USE THEREOF

(71) Applicants: Institute of Soil Science, CAS, Nanjing (CN); China Construction Eighth Engrg Division Corp, Ltd., Shanghai (CN)

(72) Inventors: Yongming LUO, Nanjing (CN); Guoming Liu, Nanjing (CN); Chen Tu, Nanjing (CN); Shuai Yang, Nanjing (CN); Xiangfeng Huang, Nanjing (CN); Zhongyuan Li, Nanjing (CN); Runlai Luo, Nanjing (CN)

(73) Assignees: Institute of Soil Science, CAS, Nanjing (CN); China Construction Eighth Engrg Division Corp, Ltd., Shanghai (CN)

(21) Appl. No.: 18/463,485

(22) Filed: Sep. 8, 2023

(30) Foreign Application Priority Data
Sep. 8, 2022 (CN) 202211100599.7

(51) Int. Cl. B01J 20/22; B01J 20/04; B01J 20/06; B01J 20/28; B01J 20/30; B01J 20/34; B09C 1/08

(52) U.S. Cl. CPC B01J 20/22; B01J 20/041; B01J 20/06; B01J 20/28009; B01J 20/2803; B01J 20/3042; B01J 20/3071; B01J 20/3085; B01J 20/3425; B01J 20/3475; B09C 1/08; B09C 2101/00

(57) ABSTRACT

Provided are a mercapto group-loaded layered double hydroxide (LDH)-based magnetic composite particle, and a preparation method and use thereof. The method includes: dissolving a water-soluble divalent magnesium salt and a water-soluble trivalent aluminum salt in water to obtain a mixed salt solution; pumping ammonia water into the mixed salt solution, and performing reaction I under stirring, subjecting an obtained product to centrifugation, and washing product obtained with deionized water; mixing the product with water, ethanol, and a coupling agent KH-580 to obtain a mixture, subjecting the mixture to reaction II while stirring to obtain mercapto group-loaded LDH; mixing the mercapto group-loaded LDH with ferroferric oxide and sodium alginate, adding deionized water thereto, and stirring to obtain a homogeneous mixed solution; adding the homogeneous mixed solution into a calcium chloride solution dropwise to form a magnetic bead; and leaving the magnetic bead to harden, and then washing and drying.

### CROSS REFERENCE TO RELATED APPLICATION

This patent application claims the benefit and priority of Chinese Patent Application No. 202211100599.7 filed with the China National Intellectual Property Administration on Sep. 8, 2022, the disclosure of which is incorporated by reference herein in its entirety as part of the present application.

### FIELD OF THE INVENTION

The present disclosure belongs to the technical field of soil pollution remediation, and relates to a mercapto group-loaded layered double hydroxide (LDH)-based magnetic composite particle, and a preparation method and use thereof.

### BACKGROUND OF THE INVENTION

Cadmium pollution in farmland soil has become one of the global soil environmental problems and then attracted widespread attention from governments and the public. Cadmium pollution in soil can cause excessive cadmium in rice, wheat and other food crops, threatening human and organism health and food safety production. Therefore, remediating cadmium-contaminated farmland soils and providing guarantee for the safe production of food crops are the current research hotspots and difficulties in the field of soil and environment remediation.

Cadmium is one of the most toxic heavy metals with teratogenic, carcinogenic, and mutagenic effects. Currently, there are two main strategies for the remediation of cadmium-contaminated soils. One is to remove heavy metals in the soil; the other is to immobilize heavy metals in the soil and reduce their environmental risks. For a long time, the remediation of cadmium polluted soil has been mainly based on the chemical stabilization of adding stabilizers to the soil. In this technology, lime, phosphate, humus, biochar or various organic/inorganic composite porous materials are used as stabilizers to adsorb and immobilize heavy metals, for example, bioavailable cadmium in the soil, thereby reducing the biotoxicity of heavy metals in the soil. However, this technology does not reduce the cadmium content in the soil, and the change of soil environment may cause the risk of releasing of immobilized cadmium. In terms of reductive removal of cadmium from the soil, phytoextraction technology is relatively emerging. But it has a long remediation period and is easily affected by biological and climatic conditions. Chemical leaching using chelating agents and the like can effectively reduce the cadmium content in the soil, but generally leads to deterioration of soil quality and health, thereby seriously affecting the agricultural production of remediated soil. Some researchers remove soil heavy metals by using waste textiles loaded with layered double hydroxides as adsorbents, which can remove heavy metals by separating the waste textiles from soil. However, the netted waste textiles may not be in sufficient contact with the soil, and it is difficult to manipulate for large areas of cadmium-contaminated farmland soil. Therefore, it is of great practical significance to seek a new economical and efficient method to remove cadmium from contaminated soil to ensure soil ecological security and food security.

### SUMMARY OF THE INVENTION

Technical problems to be solved: Aiming at the shortcomings and deficiencies of existing methods for removing cadmium from contaminated farmland soil, the present disclosure provides for the first time a mercapto group-loaded layered double hydroxide (LDH)-based magnetic composite particle (hereafter referred to as magnetic composite particles), and a preparation method and use thereof. The magnetic particle reacts with cadmium in the soil, and then the magnetic particle that adsorbs the cadmium in the soil is separated by a magnet, thereby fundamentally reducing the total content of cadmium in the soil.

Technical solutions: The present disclosure provides a method for preparing a mercapto group-loaded LDH-based magnetic composite particle, including the following steps:
S1) dissolving a water-soluble divalent metal salt and a water-soluble trivalent metal salt in water to obtain a mixed salt solution;
S2) pumping ammonia water into the mixed salt solution, performing reaction I (i.e., co-precipitation) under stirring while monitoring a pH value of a resulting reaction system, adjusting the pH value of the reaction system with the ammonia water until that the pH value is stabilized at 9.5 to 10.5;
S3) subjecting a product obtained in S2 to centrifugation, removing a resulting supernatant, washing a precipitate obtained with deionized water to obtain a product;
S4) mixing the product obtained in S3 with water, ethanol, and a coupling agent KH-580 to obtain a mixture, and subjecting the mixture to reaction II (i.e., mercapto loading) while stirring, to obtain mercapto group-loaded LDH, wherein

a mass ratio of the product to the water is in a range of 1:(8.3-18.3), a volume ratio of the ethanol to the water is 1:10.4, and a volume ratio of the KH-580 to the ethanol is in a range of 1:(7.9-8.3);
S5) mixing the mercapto group-loaded LDH with ferroferric oxide and sodium alginate, adding deionized water thereto, and stirring, to obtain a homogeneous mixed solution;
S6) adding the homogeneous mixed solution obtained in S5 into a calcium chloride solution dropwise through a pump to form a magnetic bead with a particle size of 2 mm to 4 mm; and

S7) leaving the magnetic bead obtained in S6 to harden in the calcium chloride solution, and then washing a hardened magnetic bead with water and drying, to obtain the mercapto group-loaded LDH-based magnetic composite particle.

In some embodiments, the water-soluble divalent metal salt is a magnesium salt selected from the group consisting of magnesium nitrate and magnesium chloride; and the water-soluble trivalent metal salt is an aluminum salt selected from the group consisting of aluminum nitrate and aluminum chloride; and a mass ratio of the magnesium salt to the aluminum salt is in a range of 1:(0.49-0.73), and the mixed salt solution has a total mixed salt mass concentration of from 20 g/L to 40 g/L.

In some embodiments, in S2), a volume ratio of the ammonia water to the mixed salt solution is in a range of 1:(2-2.5), and the ammonia water has a concentration of 6 mol/L to 7 mol/L; and the reaction I in S2 is conducted at a temperature of 50° C. to 100° C. for 10 to 20 hours.

In some embodiments, in S5), the ferroferric oxide and the sodium alginate each have a mass concentration of 9 g/L to 10 g/L in the homogeneous mixed solution; a mass ratio of the mercapto group-loaded LDH to the ferroferric oxide is 3:2; a mass ratio of the mercapto group-loaded LDH to the sodium alginate is 3:2; the stirring in S5) is performed at a rate of 2,000 rpm to 5,000 rpm for 2 h to 6 h to obtain the homogeneous mixed solution; and the homogeneous mixed solution is subjected to an ultrasonic treatment for 15 min to 60 min before pumping into the calcium chloride solution.

In some embodiments, in S6), the calcium chloride solution has a mass concentration of 2% to 4%.

In some embodiments, in S7), the magnetic bead is left to harden in the calcium chloride solution for 10 h to 24 h, and the drying is conducted at a temperature of 50° C. to 110° C.

The present disclosure further provides a mercapto group-loaded LDH-based magnetic composite particle prepared by the method as described in above technical solutions.

The present disclosure further provides use of the mercapto group-loaded LDH-based magnetic composite particle as described in above technical solutions for the removal of cadmium from soil.

In some embodiments, the use includes
mixing the mercapto group-loaded LDH-based magnetic composite particle with cadmium-contaminated farmland soil and water, and performing reaction III (i.e., the reaction of magnetic particles with Cd-contaminated soil) under stirring at room temperature; or
applying the mercapto group-loaded LDH-based magnetic composite particle into flooded cadmium-contaminated farmland soil, stirring and mixing, and performing reaction III for 4 h to 18 h, with an initial stirring time of 10 min to 30 min, followed by stirring for 5 min to 10 min at intervals of 1 h,
wherein the cadmium-contaminated farmland soil has a cadmium content of 0.3 mg/kg to 40 mg/kg, a pH value of 4.0 to 8.8, and a plow layer depth of 0 cm to 20 cm; and
a mass ratio of the cadmium-contaminated farmland soil to the water is in a range of 1:(1-2.5), and a mass ratio of the mercapto group-loaded LDH-based magnetic composite particle to the cadmium-contaminated farmland soil is in a range of 1:(10-50).

In some embodiments, the use further includes
recovering the mercapto group-loaded LDH-based magnetic composite particle, and regenerating recovered mercapto group-loaded LDH-based magnetic composite particle;
wherein recovering the mercapto group-loaded LDH-based magnetic composite particle includes
inserting a rod-shaped magnet with a magnetic field strength of 100 mT to 1,000 mT into flooded soil after the reaction III, stirring, taking out the magnet after the mercapto group-loaded LDH-based magnetic composite particles are attracted by the magnet, and collecting attracted mercapto group-loaded LDH-based magnetic composite particle; and
washing collected mercapto group-loaded LDH-based magnetic composite particle with tap water and drying at a temperature of 50° C. to 100° C.; and
wherein regenerating recovered mercapto group-loaded LDH-based magnetic composite particle includes
adding the recovered mercapto group-loaded LDH-based magnetic composite particle into a salt solution, and stirring or oscillating; and
withdrawing the mercapto group-loaded LDH-based magnetic composite particle, washing with water, and drying to obtain regenerated mercapto group-loaded LDH-based magnetic composite particle,
wherein the salt solution is a MgCl₂ solution or a Na₂S₂O₃ solution;
a dosage of the recovered mercapto group-loaded LDH-based magnetic composite particle in the salt solution is 100 g/L to 200 g/L; and

the recovered mercapto group-loaded LDH-based magnetic composite particle is regenerated for 0.5 h to 4 h.

Beneficial effects:by the method of preparing the mercapto group-loaded LDH-based magnetic composite particle according to the present disclosure, the magnetic beads are obtained by a one-step method that is easy to implement under mild conditions, thus greatly reducing the harsh experimental conditions such as heating, reflux, and calcination in the existing loading or modification methods. The LDHs used have a three-dimensional pore structure and a large specific surface area, which can enhence the adsorption of cadmium ions in the soil; meanwhile, the selective adsorption of cadmium in soil can be enhanced by loaded mercapto functional groups. The mercapto group-loaded LDH-based magnetic composite particle has magnetic properties, and has a particle size of 0.8 mm to 1.9 mm (average particle size of 1.4 mm), which is different from that of soil clay and silt particles. This can greatly improve the separation efficiency of the magnetic particles in flooded soils and reduce the difficulty of their separation. Moreover, in the mercapto group-loaded LDH-based magnetic composite particle, LDH functions as an adsorption component, which enhances the structural strength of sodium alginate, and is beneficial for applications in soil. The mercapto group-loaded LDH-based magnetic composite particle is easy to regenerate and recycle, and has the advantages of low cost, and applicability to different scales of remediation in cadmium-contaminated farmland soil. In this way, the cadmium content in the soil could be fundamentally reduced, thereby reducing secondary pollution.

### BRIEF DESCRIPTION OF THE DRAWINGS

FIG. 1 shows a flow chart of the process for removing cadmium from farmland soil by using the mercapto group-loaded LDH-based magnetic composite particle according to an embodiment of the present disclosure.

FIG. 2 shows X-ray diffraction (XRD) patterns of LDH and the mercapto group-loaded LDH-based magnetic composite particle according to an embodiment of the present disclosure.

FIG. 3 shows a comparison among removal rates of cadmium in farmland soil by using different magnetic particles and the mercapto group-loaded LDH-based magnetic composite particle according to an embodiment of the present disclosure (in which, magnetic particle 1 represents LDH-based magnetic particle; magnetic particle 2 represents magnetic clay particle reported in literature; the mercapto group-loaded LDH-based magnetic composite particle represents the one prepared in Example 1 of the present disclosure).

FIG. 4 shows the removal rate of cadmium in Aridisols collected from Baiyin City, Gansu Province, China by using the mercapto group-loaded LDH-based magnetic composite particle obtained in Example 2 of the present disclosure.

FIG. 5 shows removal rates of available cadmium in 3 types of soils (respectively from Xiangtan City, Hunan Province, China; Taizhou City, Zhejiang Province, China; and Baiyin City, Gansu Province, China) by using the mercapto group-loaded LDH-based magnetic composite particle obtained in Example 3 of the present disclosure.

FIGS. 6A to 6D show removal rates of cadmium in Anthrosols from Taicang City and recovery rates of magnetic particles after repeated use of the mercapto group-loaded LDH-based magnetic composite particle obtained in Example 4 of the present disclosure, in which, FIG. 6A and FIG. 6B correspond to the Cd removal rate and the recovery rate of mercapto group-loaded LDH-based magnetic composite particle in soil after being regenerated by MgCl₂ solution, respectively; and FIG. 6C and FIG. 6D correspond to the Cd removal rate and the recovery rate of mercapto group-loaded LDH-based magnetic composite particle in soil after being regenerated by Na₂S₂₀₃ solution, respectively.

FIGS. 7A to 7B show a comparison between particle sizes, in which, FIG. 7A shows particle size of the mercapto group-loaded LDH-based magnetic composite particle obtained in Example 2 of the present disclosure, and FIG. 7B shows particle size of a granular material in the patent “Magnetic solid organic sulfur adsorbent particle material containing organic sulfur adsorption group and preparation method thereof”.

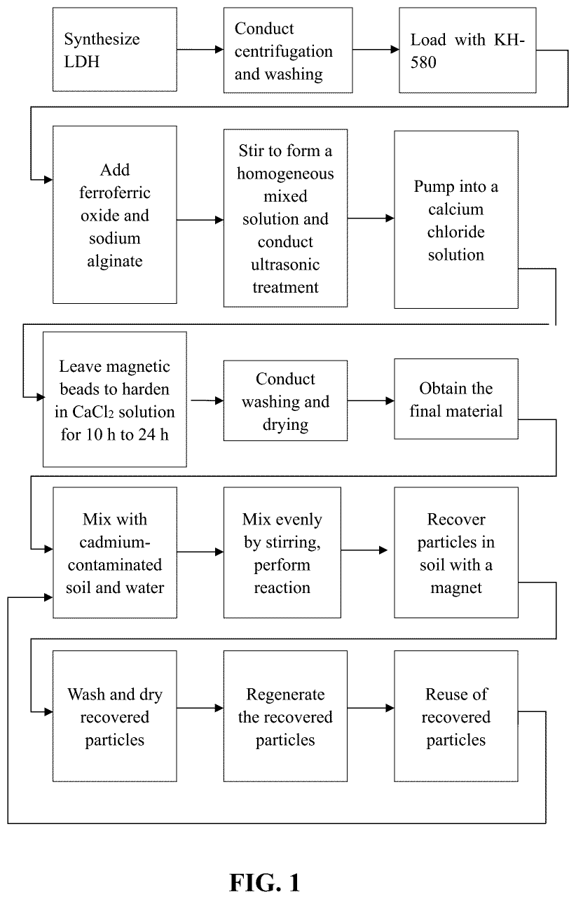

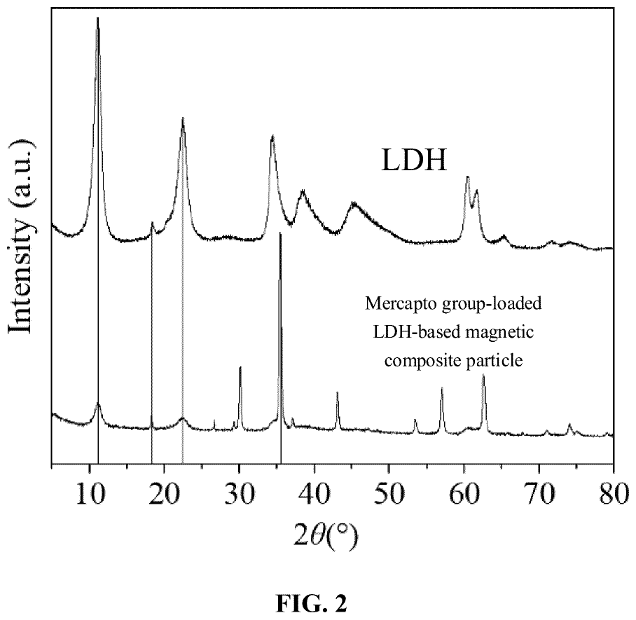

### DETAILED DESCRIPTION OF THE PREFERRED EMBODIMENTS

The present disclosure will be described in further detail below with reference to examples and accompanying drawings, but examples of the present disclosure are not limited thereto.

The experimental methods in the following examples, unless otherwise specified, are conventional methods. The chemical reagents used in each example, unless otherwise specified, are commercially available conventional products, and can be obtained through commercial purchase.

### Example 1

Step I: Preparation of mercapto group-loaded LDH-based magnetic composite particle

S1) 92.28 g of Mg(NO₃)₂·6H₂O and 45.0 g of Al(NO₃)₃·9H₂O were dissolved in 300 mL of deionized water, and stirred evenly in a 2.0 L beaker on a heated magnetic stirrer at 60° C., obtaining a mixed salt solution.

S₂) 600 mL of 50% (v/v) ammonia water was slowly pumped into the mixed salt solution obtained in S1 for the co-precipitation reaction with continuous stirring; while a pH value of the resulting reaction system was monitored to be 9.65 during the co-precipitation. After the ammonia water was completely added, 80.0 mL of concentrated ammonia water was further pumped into the reaction system such that the pH value of the resulting reaction system was stabilized at 9.75. The resulting mixture was left to stand at 60° C. and aged for 12 h (overnight).

S₃) A mixture obtained in S₂ was divided into a 200 mL centrifuge bottle, centrifuged at 3,000 rpm for 10 min on a centrifuge, and taken out. A supernatant obtained after centrifugation was discarded. Deionized water was added to a resulting residue and they were mixed evenly, an obtained mixture was then centrifuged again and a resulting supernatant was discarded. Washing was conducted in this way and repeated 4 to 5 times, and an obtained washed substance was centrifuged to obtain a product.

S₄) 38.4 mL of absolute ethanol, 4.8 mL of KH-580, and 400 mL of deionized water were added to the product obtained in S₃ to form a mixed solution, and the mixed solution was stirred mechanically at room temperature for 2.5 h to obtain mercapto group-loaded LDH, wherein a volume ratio of the absolute ethanol to the deionized water was 1:10.4, and a volume ratio of the KH-580 to the absolute ethanol was 1:8.0.

S₅) The mercapto group-loaded LDH obtained in S₄ was mixed with 20.0 g of a ferroferric oxide powder (or iron powder) and 20.0 g of sodium alginate. 1,600 mL of deionized water was further added thereto. The resulting mixture was stirred at 4,000 rpm for 5 h in a stirrer to obtain a homogeneous mixed solution.

S₆) The homogeneous mixed solution obtained in S₅ was subjected to ultrasonic treatment in an ultrasonic cleaner for 30 min to remove air bubbles in the mixed solution, and then added dropwise to a calcium chloride solution through a pump to form magnetic beads with a particle size of 2 mm to 4 mm.

S₇) The magnetic beads obtained in S₆ were left to harden in the calcium chloride solution for 14 h (overnight), and then washed 5 times with tap water. The washed magnetic beads were evenly distributed on a tray, and dried at 100° C. for 5 h to obtain the mercapto group-loaded LDH-based magnetic composite particle.

Step II: Removal of cadmium in the contaminated farmland soil

A typical cadmium-contaminated farmland soil collected from Taicang City, Jiangsu Province, China was selected, with a soil type of Anthrosols. The soil total cadmium content and cadmium content extracted with 0.43 mol/L nitric acid are shown in Table 1.

TABLE 1
Properties of cadmium-contaminated farmland soil

| | | | | | | Cadmium |
|---|---|---|---|---|---|---|
| | | | | Clay | Total | extracted with |
| | | | Organic matter | grain | cadmium | 0.43 mol/L |
| Sampling site | Soil type | pH | (g/kg) | (%) | (mg/kg) | HNO₃ (mg/kg) |
| Taicang City, | Anthrosols | 6.51 | 44.2 | 38.72 | 0.79 | 0.59 |
| Jiangsu | | | | | | |
| Province, | | | | | | |
| China | | | | | | |

S8) 2.0 g of the mercapto group-loaded LDH-based magnetic composite particle obtained in S7 was mixed with 10.0 g of the cadmium-contaminated farmland soil and 20 mL of water. The resulting mixture was mixed evenly in a shaker at room temperature to allow a full reaction. Alternatively, 2.0 g of the mercapto group-loaded LDH-based magnetic composite particle obtained in S7 was added to 10.0 g of flooded cadmium-contaminated farmland soil.

S9) After stirring and mixing evenly, the mercapto group-loaded LDH-based magnetic composite particle interacted with the soil for 15 h.

Step III: Recovery of mercapto group-loaded LDH-based magnetic composite particle

S10) A bar-shaped magnet with a magnetic field strength of 300 mT was inserted into the flooded soil after the reaction in S9, and a stirring was performed. After the mercapto group-loaded LDH-based magnetic composite particle was attracted by the magnet, the magnet was taken out. The mercapto group-loaded LDH-based magnetic composite particles attracted on a surface of the magnetic bar were removed. The magnetic bar was inserted again into the flooded soil after the reaction to check whether the mercapto group-loaded LDH-based magnetic composite particle was fully recovered.

S11) The mercapto group-loaded LDH-based magnetic composite particles recovered in S10 were washed 5 times with tap water and dried at 100° C. The weight of recovered mercapto group-loaded LDH-based magnetic composite particle was 1.97 g±0.01 g, and the recovery rate of mercapto group-loaded LDH-based magnetic composite particle was 98.3%.

The original soil and the soil obtained after recovering mercapto group-loaded LDH-based magnetic composite particle were naturally air-dried, ground, and sieved with a 10-mesh sieve, obtaining those passing through the 10-mesh sieve. 2.00 g of soil passing through the 10-mesh sieve was put into a centrifuge tube, and 20.0 mL of 0.43 mol/L nitric acid was added thereto. The centrifuge tubes were shaken at 25° C. for 4 h, and centrifuged. A resulting supernatant was passed through a 0.45 μm filter membrane, and cadmium concentration in the supernatant was determined by inductively coupled plasma-mass spectrometry (ICP-MS). A cadmium removal rate was calculated as follows:

$$Cadmium removal rate ( \% ) = \frac{\begin{matrix}Cadmium content in original soil - \\ Cadmium content in soil after treatment\end{matrix}}{Cadium content in original soil} \times 100 \% \qquad Equation ( 1 )$$

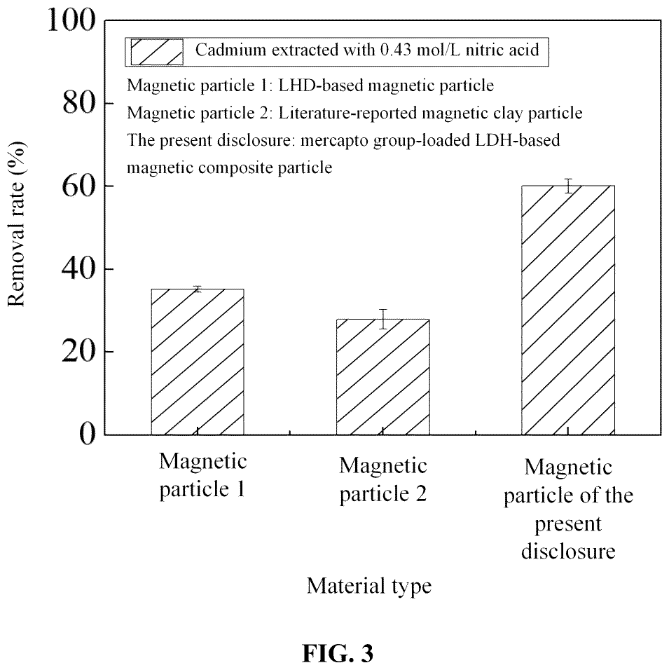

As shown in FIG. 3, after being treated once by using the magnetic particle 1 (LDH-based magnetic particles without mercapto group) and magnetic particle according to the present disclosure (i.e., mercapto group-loaded LDH-based magnetic composite particles) were separated from the soil by a magnet, and the removal rates of cadmium from the soil after one treatment were 35.3% and 60.2%, respectively; while the magnetic particle 2 reported in the literature achieved a cadmium removal rate of 27.9% for this soil. It can be seen that the Cd removal rate by mercapto group-loaded LDH-based magnetic composite particle according to the present disclosure was significantly better than those of the magnetic particles 1 and 2.

Step IV: Regeneration and reuse of mercapto group-loaded LDH-based magnetic composite particles

S12) The recovered mercapto group-loaded LDH-based magnetic composite particles obtained in S11 were added to 20 mL of 0.10 mol/L MgCl₂ solution, and stirred or shaken to allow reaction for 1.00 h.

S13) The mercapto group-loaded LDH-based magnetic composite particle obtained in S12 was withdrawn, washed with tap water, and dried at 100° C. to obtain a regenerated mercapto group-loaded LDH-based magnetic composite particle.

### Example 2

Step I: Preparation of mercapto group-loaded LDH-based magnetic composite particle

S1) 15.38 g of Mg(NO₃)₂·6H₂O and 7.50 g of Al(NO₃)₃·9H₂O were dissolved in 50 mL of deionized water, and stirred evenly in a 1.0 L beaker on a heated magnetic stirrer at 60° C., obtaining a mixed salt solution.

S₂) 100 mL of 50% (v/v) ammonia water was slowly pumped into the mixed salt solution obtained in S1 for the co-precipitation reaction with continuous stirring; while a pH value of the resulting reaction system was monitored to be 9.6 during the co-precipitation. After adding the ammonia water, 80.0 mL of concentrated ammonia water was further pumped into the reaction system such that the pH value of the resulting reaction system was stabilized at 9.75. The resulting mixture was left to stand at 60° C. and aged for 12 h.

S3) A mixture obtained in S2 was centrifuged at 3,000 rpm for 10 min on a centrifuge, and taken out. A supernatant obtained after centrifugation was discarded. Deionized water was added to a resulting residue and they were mixed evenly, an obtained mixture was then centrifuged again and a resulting supernatant was discarded. Washing was conducted in this way and repeated 5 times, and an obtained washed substance was centrifuged to obtain a product.

S4) 6.4 mL of absolute ethanol, 0.81 mL of KH-580, and 66.7 mL of deionized water were added to the product obtained in S3 to form a mixed solution, and the mixed solution was stirred mechanically at room temperature for 2.5 h to obtain mercapto group-loaded LDH, wherein a volume ratio of the absolute ethanol to the deionized water was 1:10.4, and a volume ratio of the KH-580 to the absolute ethanol was 1:7.9.

S5) The mercapto group-loaded LDH obtained in S4 was mixed with 3.33 g of a ferroferric oxide powder (or iron powder) and 3.33 g of sodium alginate. 266.7 mL of deionized water was further added thereto. The resulting mixture was stirred at 4,000 rpm for 4.0 h in a stirrer to obtain a homogeneous mixed solution.

S6) The homogeneous mixed solution obtained in S5 was subjected to ultrasonic treatment in an ultrasonic cleaner for 30 min to remove air bubbles in the mixed solution, and then added dropwise to a calcium chloride solution through a pump to form magnetic beads with a particle size of 2 mm to 4 mm.

S7) The magnetic beads obtained in S6 were left to harden in the calcium chloride solution for 12 h (overnight), and then washed 5 times with tap water. The washed magnetic beads were evenly distributed on a tray, and dried at 100° C. for 5 h to obtain the mercapto group-loaded LDH-based magnetic composite particle.

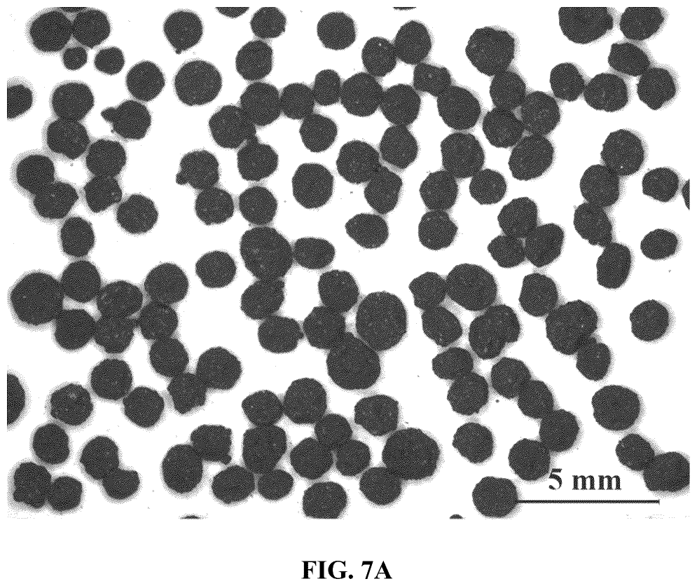

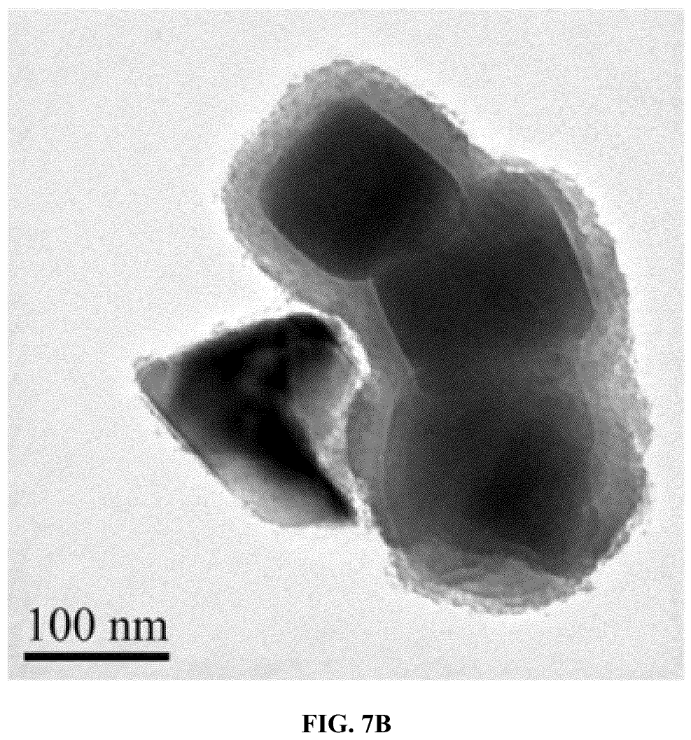

The particle size of the mercapto group-loaded LDH-based magnetic composite particle obtained in Example 2 is shown in FIG. 7A; while particle size of a granular material in the patent “Magnetic solid organic sulfur adsorbent particle material containing organic sulfur adsorption group and preparation method thereof” is shown in FIG. 7B.

Step II: Removal of Cadmium in Farmland Soil

A typical cadmium-contaminated farmland soil collected from Baiyin City, Gansu Province, China was selected, with a soil type of Aridisols. The soil total cadmium content and cadmium content extracted with 0.43 mol/L HNO₃ are shown in Table 2.

TABLE 2
Properties of cadmium-contaminated farmland
soil from Baiyin City, Gansu Province, China

| | | | Total | Cadmium extracted |
|---|---|---|---|---|
| | | | cadmium | with 0.43 mol/L |
| Sampling site | Soil type | pH | (mg/kg) | HNO₃ (mg/kg) |
| Baiyin City, Gansu | Aridisols | 8.67 | 1.13 | 0.62 |
| Province, China | | | | |

S8) 2.0 g of the mercapto group-loaded LDH-based magnetic composite particle obtained in S7 was mixed with 10.0 g of the cadmium-contaminated farmland soil and 20 mL of water. The resulting mixture was mixed evenly in a shaker at room temperature to allow a full reaction.

Alternatively, 2.0 g of the mercapto group-loaded LDH-based magnetic composite particle obtained in S7 was added to 10.0 g of flooded cadmium-contaminated farmland soil.

S9) After stirring and mixing evenly, the mercapto group-loaded LDH-based magnetic composite particle interacted with the soil for 5 h.

Step III: Recovery of mercapto group-loaded LDH-based magnetic composite particles

S10) A bar-shaped magnet with a magnetic field strength of 300 mT was inserted into the flooded soil after the reaction in S9, and a stirring was performed. After the mercapto group-loaded LDH-based magnetic composite particle was attracted by the magnet, the magnet was taken out. The mercapto group-loaded LDH-based magnetic composite particles attracted on a surface of the magnetic bar were removed. The magnetic bar was inserted again into the flooded soil after the reaction to check whether the mercapto group-loaded LDH-based magnetic composite particle was fully recovered.

S11) The mercapto group-loaded LDH-based magnetic composite particles recovered in S10 were washed 5 times with tap water and dried at 100° C. The weight of recovered mercapto group-loaded LDH-based magnetic composite particles was 1.98 g, and the recovery rate of mercapto group-loaded LDH-based magnetic composite particle was 98.8%.

The original soil and the soil obtained after recovering mercapto group-loaded LDH-based magnetic composite particle were naturally air-dried, ground, and sieved with a 10-mesh sieve, obtaining those passing through the 10-mesh sieve. 2.00 g of soil passing through the 10-mesh sieve was put into a centrifuge tube, and 20.0 mL of 0.43 mol/L nitric acid was added thereto. The centrifuge tubes were shaken at 25° C. for 4 h, and centrifuged. A resulting supernatant was passed through a 0.4511m filter membrane, and cadmium concentration in the supernatant was determined by inductively coupled plasma-mass spectrometry (ICP-MS).

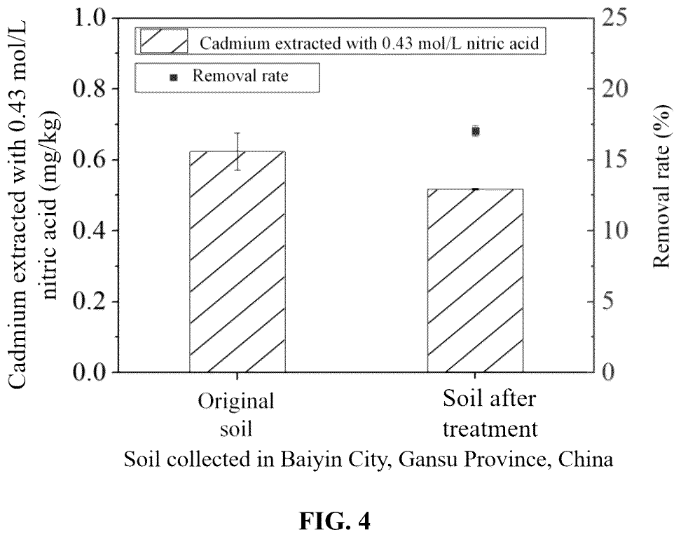

A cadmium removal rate was calculated according to Equation (1). As shown in FIG. 4, after being treated once by the mercapto group-loaded LDH-based magnetic composite particles and magnetic retrieval, the content of cadmium extracted with dilute nitric acid (0.43 mol/L) in soil decreases from 0.62 mg/kg to 0.52 mg/kg, while the removal rate of nitric acid-extracted cadmium in soil is 17.1%.

Step IV: Regeneration and reuse of mercapto group-loaded LDH-based magnetic composite particles

S12) The recovered mercapto group-loaded LDH-based magnetic composite particles obtained in S11 were added to 15 mL of 0.10 mol/L MgCl₂ solution, and stirred or shaken to allow reaction for 1.00 h.

S13) The mercapto group-loaded LDH-based magnetic composite particles obtained in S12 were withdrawn, washed with tap water, and dried at 100° C. to obtain regenerated mercapto group-loaded LDH-based magnetic composite particles.

### Example 3

Step I: Preparation of mercapto group-loaded LDH-based magnetic composite particle

S1) 92.28 g of Mg(NO₃)₂·6H₂O and 45.0 g of Al(NO₃)₃·9H₂O were dissolved in 300 mL of deionized water, and stirred evenly in a 2.0 L beaker on a heated magnetic stirrer at 60° C., obtaining a mixed salt solution.

S2) 600 mL of 50% (v/v) ammonia water was slowly pumped into the mixed salt solution obtained in S1 for the co-precipitation reaction with continuous stirring, while a pH value of the resulting reaction system was monitored to be 9.75. After the ammonia water was completely added, 80.0 mL of concentrated ammonia water was further pumped into the reaction system such that the pH value of the resulting reaction system was stabilized at 9.75. The resulting mixture was left to stand at 60° C. and aged for 15 h (i.e., overnight).

S3) The mixture obtained in S2 was divided into a 250 mL centrifuge bottles, centrifuged at 4,000 rpm for 8 min, and the supernatant obtained after centrifugation was discarded. Deionized water was added to a resulting residue again, and they were mixed evenly. An obtained mixture was then centrifuged again and the supernatant was discarded. Washing was conducted in this way and repeated 4 to 5 times, and an obtained washed substance was centrifuged to obtain a product.

S4) 38.4 mL of absolute ethanol, 4.8 mL of KH-580, and 400 mL of deionized water were added to the product obtained in S3 to form a mixed solution, and the mixed solution was stirred mechanically at room temperature for 2.5 h to obtain mercapto group-loaded LDH, wherein a volume ratio of the absolute ethanol to the deionized water was 1:10.4, and a volume ratio of the KH-580 to the absolute ethanol was 1:8.0.

S5) The mercapto group-loaded LDH obtained in S4 was mixed with 20.0 g of a ferroferric oxide powder (or iron powder) and 20.0 g of sodium alginate. 1,600 mL of deionized water was further added thereto. The resulting mixture was stirred at 4,000 rpm for 4 h in a stirrer to obtain a homogeneous mixed solution.

S6) The homogeneous mixed solution obtained in S5 was subjected to ultrasonic treatment in an ultrasonic cleaner for 30 min to remove air bubbles in the mixed solution, and then added dropwise to a calcium chloride solution through a pump to form magnetic beads with a particle size of 2 mm to 4 mm.

S7) The magnetic beads obtained in S6 were left to harden in the calcium chloride solution for 14 h (overnight), and then washed 5 times with tap water afterward. The washed magnetic beads were evenly distributed on a tray, and dried at 100° C. for 5 h to obtain the mercapto group-loaded LDH-based magnetic composite particle.

Step II: Removal of Cadmium in Farmland Soil

3 types of typical cadmium-contaminated farmland soil were selected. The available cadmium (extracted by diethylenetriaminepentaacetic acid (DTPA) and triethylamine solution (TEA) according to NY/T 890-2004, China) in soils are shown in Table 3.

TABLE 3
pH and available cadmium contents of
cadmium-contaminated farmland soils

| | | | Available |
|---|---|---|---|
| | | | cadmium |
| Sampling site | Soil type | pH | (mg/kg) |
| Xiangtan City, Hunan Province, China | Anthrosols | 4.62 | 0.54 |
| Taizhou City, Zhejiang Province, China | Anthrosols | 5.61 | 0.40 |
| Baiyin City, Gansu Province, China | Aridisols | 8.67 | 0.34 |

S8) 3.0 g of the mercapto group-loaded LDH-based magnetic composite particles obtained in S7 were mixed with 15.0 g of the cadmium-contaminated farmland soil and 30 mL of water. The resulting mixture was mixed evenly in a shaker at room temperature to allow a full reaction. Alternatively, 3.0 g of the mercapto group-loaded LDH-based magnetic composite particles obtained in S7 were added to 15.0 g of flooded cadmium-contaminated farmland soil.

S9) After stirring and mixing evenly, the mercapto group-loaded LDH-based magnetic composite particle interacted with the soil for 5 h.

Step III: Recovery of Mercapto Group-Loaded LDH-Based Magnetic Composite Particle

S10) A bar-shaped magnet with a magnetic field strength of 300 mT was inserted into the flooded soil after the reaction in S9, and a stirring was performed. After the mercapto group-loaded LDH-based magnetic composite particle was attracted by the magnet, the magnet was taken out. The mercapto group-loaded LDH-based magnetic composite particles attracted on a surface of the magnetic bar were removed. The magnetic bar was inserted again into the flooded soil after the reaction to check whether the mercapto group-loaded LDH-based magnetic composite particle was fully recovered.

S11) The mercapto group-loaded LDH-based magnetic composite particles recovered in S10 were washed 5 times with tap water and dried at 100° C. The weights of recovered mercapto group-loaded LDH-based magnetic composite particles recovered after treating solis from Xiangtan City in Hunan Province of China; Taizhou City in Zhejiang Province of China, and Baiyin City in Gansu Province of China were 3.00, 3.01, and 3.01 g, respectively, indicating that the recovery rate of mercapto group-loaded LDH-based magnetic composite particle was 100%.

The original soil and the soil obtained after recovering mercapto group-loaded LDH-based magnetic composite particle were naturally air-dried, ground, and sieved with a 10-mesh sieve, obtaining those passing through a 10-mesh sieve. 5.00 g of soil passing through the 10-mesh sieve was put into a centrifuge tube, and 10.0 mL of a DTPA extraction agent (0.005 mol/L diethylenetriaminepentaacetic acid (DTPA), 0.01 mol/L CaCl 2, and 0.1 mol/L triethylamine (TEA)) was added thereto. The resulting mixture was shaken at 25° C. for 2 h, and centrifuged. A resulting supernatant was passed through a 0.45 μm filter membrane, and cadmium concentration in the supernatant was determined by inductively coupled plasma-mass spectrometry (ICP-MS).

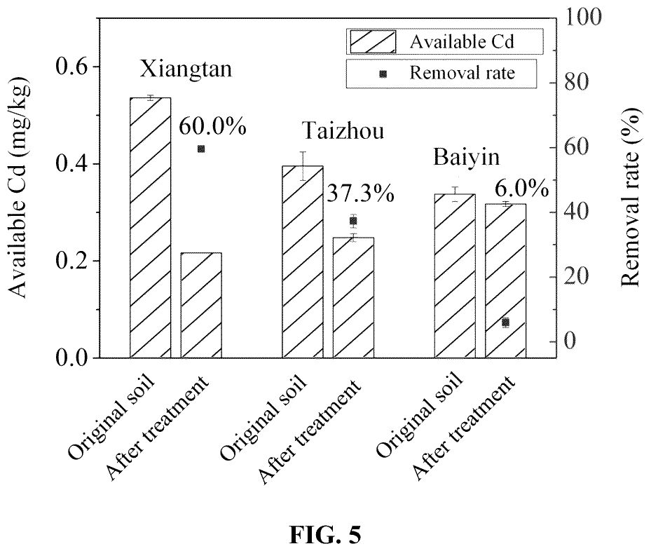

Cadmium removal rate was calculated according to Equation (1). As shown in FIG. 5, after treating once by using the mercapto group-loaded LDH-based magnetic composite particle according to the present disclosure and magnetic separation, removal rates of available cadmium in soils collected from Xiangtan City in Hunan Province of China, Taizhou City in Zhejiang Province of China, and Baiyin City in Gansu Province of China are 60.0%, 37.3%, and 6.0%, respectively.

### Example 4

Step I: Preparation of mercapto group-loaded LDH-based magnetic composite particle

S1) 92.28 g of Mg(NO₃)₂·6H₂O and 45.0 g of Al(NO₃)₃·9H₂O were dissolved in 300 mL of deionized water, and stirred evenly in a 2.0 L beaker on a heated magnetic stirrer at 60° C., obtaining a mixed salt solution.

S2) 600 mL of 50% (v/v) ammonia water was slowly pumped into the mixed salt solution obtained in S1 for the co-precipitation reaction with constantly stirring; while a pH value of the resulting reaction system was monitored to be 9.75 during the co-precipitation. After the ammonia water was completely added, 80.0 mL of concentrated ammonia water was further added dropwise into the reaction system such that the pH value of the resulting reaction system was stabilized at 9.75. The resulting mixture was left to stand at 60° C. and aged for 12 h. A resulting mixed solution had a pH value of 9.73.

S3) A mixture obtained in S2 was divided into a 200 mL centrifuge bottle, centrifuged at 4,000 rpm for 8 min on a centrifuge, and withdrawn. A supernatant obtained after centrifugation was discarded. Deionized water was added to a resulting residue, and they were mixed evenly, an obtained mixture was then centrifuged again and a resulting supernatant was discarded. Washing was conducted in this way and repeated 5 times, and an obtained washed substance was centrifuged to obtain a product.

S4) 38.4 mL of absolute ethanol, 4.8 mL of KH-580, and 400 mL of deionized water were added to the product obtained in S3 to form a mixed solution, and the mixed solution was stirred mechanically at room temperature for 3.0 h to obtain mercapto group-loaded LDH, wherein a volume ratio of the ethanol to the deionized water was 1:10.4, and a volume ratio of the KH-580 to the absolute ethanol was 1:8.0.

S5) The mercapto group-loaded LDH obtained in S4 were mixed with 20.0 g of a ferroferric oxide powder (or iron powder) and 20.0 g of sodium alginate. 1,600 mL of deionized water was further added thereto. The resulting mixture was stirred at 4,000 rpm for 5 h in a stirrer to obtain a homogeneous mixed solution.

S6) The homogeneous mixed solution obtained in S5 was subjected to ultrasonic treatment in an ultrasonic cleaner for 30 min to remove air bubbles in the mixed solution, and then added dropwise to a calcium chloride solution with a mass fraction of 2.5% through a pump to form magnetic beads with a particle size of 2 mm to 4 mm.

S7) The magnetic beads obtained in S6 were left to harden in the calcium chloride solution for 12 h, and then washed 5 times with tap water. The washed magnetic beads were evenly distributed on a tray, and dried at 100° C. for 5 h to obtain the mercapto group-loaded LDH-based magnetic composite particle.

Step II: Removal of Cadmium in Farmland Soil

A typical cadmium-contaminated farmland soil collected from Taicang City, Jiangsu Province, China was selected, with a soil type of Anthrosols. The soil total cadmium content and cadmium content extracted with 0.43 mol/L nitric acid are shown in Table 4.

TABLE 4
Properties of cadmium-contaminated farmland soil

| | | | Cadmium extracted |
|---|---|---|---|
| | | | with 0.43 mol/L |
| Sampling site | Soil type | pH | HNO₃ (mg/kg) |
| Taicang City, Jiangsu | Anthrosols | 6.55 | 1.13 |
| Province, China | | | |

S8) 1.5 g of the mercapto group-loaded LDH-based magnetic composite particle obtained in S7 was mixed with 15.0 g of the cadmium-contaminated farmland soil and 30 mL of water. The resulting mixture was mixed evenly in a shaker at room temperature to allow a full reaction. Alternatively, 1.5 g of the mercapto group-loaded LDH-based magnetic composite particle obtained in S7 was added to 15.0 g of flooded cadmium-contaminated farmland soil.

S9) After stirring and mixing evenly, the mercapto group-loaded LDH-based magnetic composite particle interacted with the soil for 5 h.

Step III: Recovery of mercapto group-loaded LDH-based magnetic composite particle

S10) A bar-shaped magnet with a magnetic field strength of 300 mT was inserted into the flooded soil after the reaction in S9, and a stirring was performed. After the mercapto group-loaded LDH-based magnetic composite particle was attracted by the magnet, the magnet was taken out. The mercapto group-loaded LDH-based magnetic composite particles attracted on a surface of the magnetic bar were removed. The magnetic bar was inserted again into the flooded soil after the reaction to check whether the mercapto group-loaded LDH-based magnetic composite particle was fully recovered.

S11) The mercapto group-loaded LDH-based magnetic composite particle recovered in S10 was washed 5 times with tap water and dried at 100° C. The weight of recovered mercapto group-loaded LDH-based magnetic composite particle was weighed.

The original soil and the soil obtained after recovering mercapto group-loaded LDH-based magnetic composite particle were naturally air-dried, ground, and sieved with a 10-mesh sieve, obtaining those passing through the 10-mesh sieve. 2.00 g of soil passing through the 10-mesh sieve was put into a centrifuge tube, and 20.0 mL of 0.43 mol/L nitric acid was added thereto. The resulting mixture was shaken at 25° C. for 4 h, and centrifuged. A resulting supernatant was passed through a 0.45 μm filter membrane, and a cadmium concentration in the supernatant was determined by inductively coupled plasma-mass spectrometry (ICP-MS).

Step IV: Regeneration and reuse of mercapto group-loaded LDH-based magnetic composite particles

S12) The recovered mercapto group-loaded LDH-based magnetic composite particles obtained in S11 were added to 30 mL of 0.10 mol/L MgCl₂ solution, and stirred or shaken to allow reaction for 1.00 h. Alternatively, the recovered mercapto group-loaded LDH-based magnetic composite particle was added to 30 mL of 0.01 mol/L Na₂S₂O₃ solution, and stirred or shaken to allow reaction for 1.00 h.

S13) The mercapto group-loaded LDH-based magnetic composite particle obtained in S12 was taken out, washed with tap water, and dried at 100° C. to obtain a regenerated mercapto group-loaded LDH-based magnetic composite particle.

S14) 1.5 g of the regenerated mercapto group-loaded LDH-based magnetic composite particle obtained in S13 was mixed with 15.0 g of original contaminated soil in Taicang City, Jiangsu Province, China and 30 mL of water. The resulting mixture was mixed evenly in a shaker at room temperature to allow a full reaction. Alternatively, the regenerated mercapto group-loaded LDH-based magnetic composite particle obtained in S13 was added to 15.0 g of flooded cadmium-contaminated farmland soil.

S15) After stirring and mixing evenly, the mercapto group-loaded LDH-based magnetic composite particle interacted with the soil for 5 h.

Steps S10 to S15 were repeated sequentially, to obtain the recovery rate of 2^{nd} utilization (i.e., treating with one regenerated after the first utilization) and 3^{rd} utilization (i.e., treating with one regenerated after the second utilization) of the mercapto group-loaded LDH-based magnetic composite particle and the removal rate of cadmium in the original cadmium-contaminated farmland soil.

A cadmium removal rate was calculated according to Equation (1), and a cadmium removal rate in soil was obtained.

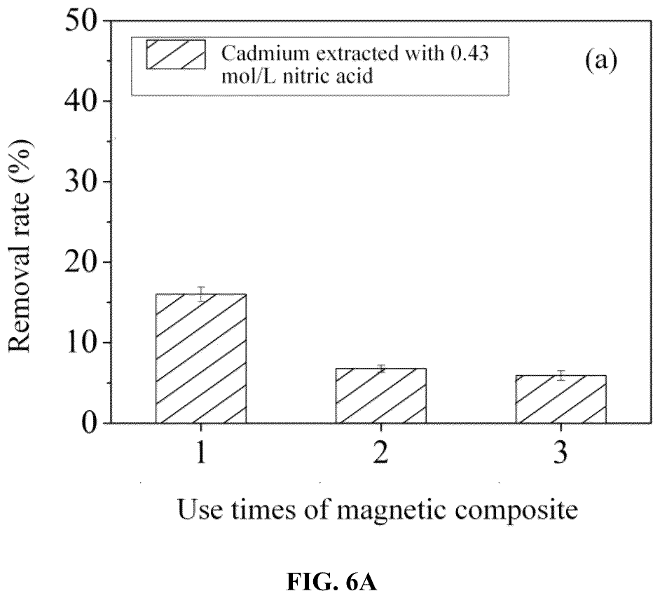

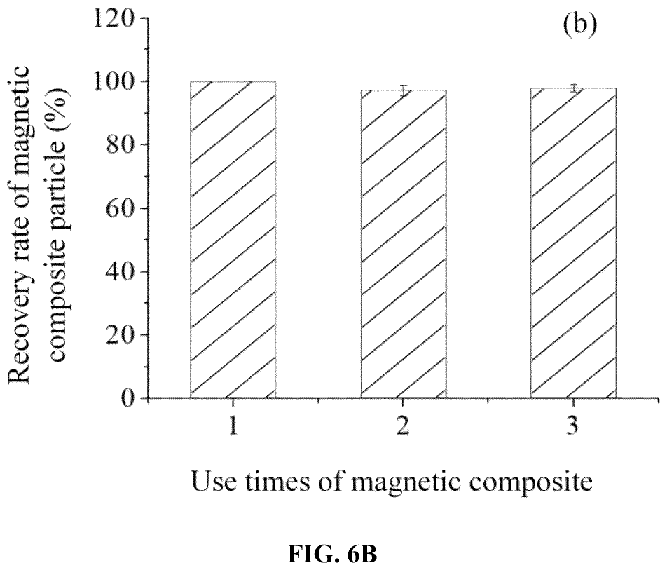

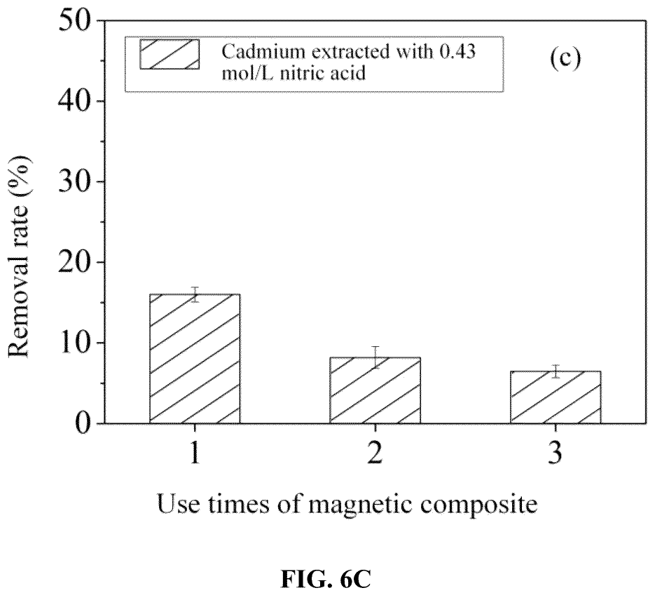

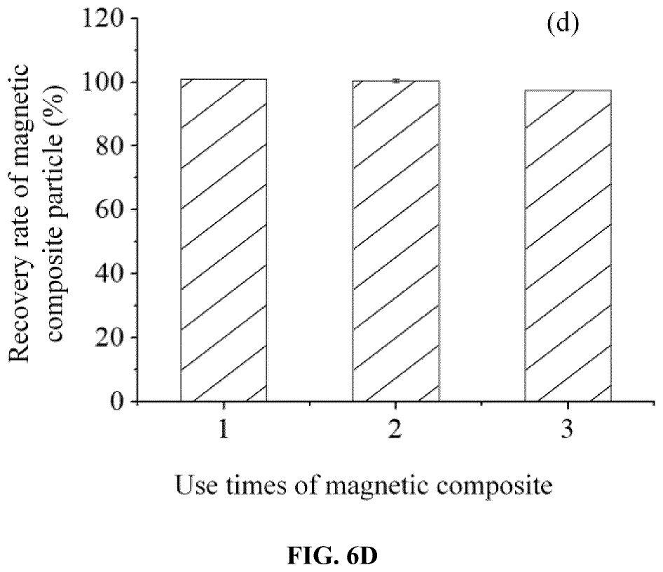

As shown in FIG. 6A and FIG. 6B, after being treated once by the new mercapto group-loaded LDH-based magnetic composite particle according to the present disclosure and magnetic separation, the removal rate of cadmium in soil is 16.0%±0.9%; the second utilization (i.e., treating with one regenerated after the first utilization) and third utilization (i.e., treating with one regenerated after the second utilization) of the mercapto group-loaded LDH-based magnetic composite particle result in a cadmium removal rate in soil of 6.8%±0.4% and 5.9%±0.6%, respectively. The recovery rates after the first utilization (i.e., treating with new mercapto group-loaded LDH-based magnetic composite particle), second utilization (i.e., treating with one regenerated after the first utilization) and third utilization (i.e., treating with one regenerated after the second utilization) of the mercapto group-loaded LDH-based magnetic composite particle are 99.9%, 97.2%, and 97.9%, respectively. It can be seen from FIG. 6C and FIG. 6D that, with respect to the mercapto group-loaded LDH-based magnetic composite particle, the removal rates of cadmium in soil through the 2^{nd} utilization and 3^{rd} utilization of the mercapto group-loaded LDH-based magnetic composite particle are 8.2%±1.4% and 6.5%±0.8%, respectively. The recovery rates after the 1st 2^{nd} and 3^{rd} utilization (defined as above) of mercapto group-loaded LDH-based magnetic composite particle are 100%, 100%, and 97.5%, respectively.

The above embodiments are merely preferred solutions of the present disclosure and are not intended to limit the present disclosure in any form, and other variations and modifications may be made without departing from the technical solutions of the present disclosure as set forth in the appended claims.

What is claimed is:

1. A method for preparing a mercapto group-loaded layered double hydroxide-based magnetic composite particle, comprising the steps of
S1) dissolving a water-soluble divalent magnesium salt and a water-soluble trivalent aluminum salt in water, to obtain a mixed salt solution;
S2) pumping ammonia water into the mixed salt solution, performing reaction I under stirring while monitoring a pH value of a resulting reaction system, adjusting the pH value of the resulting reaction system with the ammonia water until the pH value is stabilized at 9.5 to 10.5, and conducting aging overnight;
S3) subjecting a product obtained in S2 to centrifugation while washing with deionized water, and removing a supernatant to obtain a product;
S4) mixing the product obtained in S3 with water, ethanol, and a coupling agent KH-580 by stirring to obtain a mixture, and subjecting the mixture to reaction II while stirring, to obtain mercapto group-loaded layered double hydroxide (LDH), wherein
a mass ratio of the product obtained in S3 to the water is in a range of 1: (8.3-18.3), a volume ratio of the ethanol to the water is 1:10.4, and a volume ratio of the KH-580 to the ethanol is in a range of 1: (7.9-8.3);
S5) mixing the mercapto group-loaded LDH with ferroferric oxide and sodium alginate, adding deionized water thereto, and stirring, to obtain a homogeneous mixed solution;
S6) adding the homogeneous mixed solution obtained in S5 into a calcium chloride solution dropwise through a pump to form a magnetic bead with a particle size of 2 mm to 4 mm; and
S7) leaving the magnetic bead obtained in S6 to harden in the calcium chloride solution for a certain period of time, and then washing with water and drying, to obtain the mercapto group-loaded LDH-based magnetic composite particle.

2. The method as claimed in claim 1, wherein in S1), the water-soluble divalent magnesium salt is selected from the group consisting of magnesium nitrate and magnesium chloride;
the water-soluble trivalent aluminum salt selected from the group consisting of aluminum nitrate and aluminum chloride;
a mass ratio of the water-soluble divalent magnesium salt to the water-soluble trivalent aluminum salt is in a range of 1: (0.49-0.73); and
the mixed salt solution has a total mixed salt mass concentration of 20 g/L to 40 g/L.

3. The method as claimed in claim 1, wherein in S2), a volume ratio of the ammonia water to the mixed salt solution is in a range of 1: (2-2.5);
the ammonia water has a concentration of 6 mol/L to 7 mol/L; and
the reaction I in S₂ is conducted at a temperature of 50° C. to 100° C. for 10 h to 20 h.

4. The method as claimed in claim 1, wherein in S5), the ferroferric oxide and the sodium alginate each have a mass concentration of 9 g/L to 10 g/L in the homogeneous mixed solution;
a mass ratio of the mercapto-loaded LDH to the ferroferric oxide is 3:2;
a mass ratio of the mercapto-loaded LDH to the sodium alginate is 3:2;
the stirring in S₅) is performed at a rate of 2,000 rpm to 5,000 rpm for 2 h to 6 h to obtain the homogeneous mixed solution; and
the homogeneous mixed solution is subjected to an ultrasonic treatment for 15 min to 60 min before being added into the calcium chloride solution through the pump.

5. The method as claimed in claim 1, wherein in S6, the calcium chloride solution has a mass concentration of 2% to 4%.

6. The method as claimed in claim 1, wherein in S7, the magnetic bead obtained in S6 is left to harden in the calcium chloride solution for 10 h to 24 h, and the drying is conducted at a temperature of 50° C. to 110° C.

7. A mercapto group-loaded layered double hydroxide-based magnetic composite particle prepared by the method as claimed in claim 1.

8. A method for removing cadmium in soil, comprising
using the mercapto group-loaded layered double hydroxide-based magnetic composite particle prepared by the method as claimed in claim 1.

9. The method as claimed in claim 8, wherein the method comprises
mixing mercapto group-loaded LDH-based magnetic composite particle with cadmium-contaminated farmland soil and water, and performing reaction III under stirring at room temperature; or
applying the mercapto group-loaded LDH-based magnetic composite particle to flooded cadmium-contaminated farmland soil, and mixing, and performing reaction III for 4 h to 18 h, with an initial stirring time of 10 min to 30 min, followed by stirring for 5 min to 10 min at intervals of 1 h,
wherein the cadmium-contaminated farmland soil has a cadmium content of 0.3 mg/kg to 40 mg/kg, a pH value of 4.0 to 8.8, and a plow layer depth of 0 cm to 20 cm; and
a mass ratio of the cadmium-contaminated farmland soil to the water is in a range of 1: (1-2.5), and a mass ratio of the mercapto group-loaded LDH-based magnetic composite particle to the cadmium-contaminated farmland soil is in a range of 1: (10-50).

10. The method as claimed in claim 9, further comprising
recovering the mercapto group-loaded LDH-based magnetic composite particle, and regenerating recovered mercapto group-loaded LDH-based magnetic composite particle;
wherein recovering the mercapto group-loaded LDH-based magnetic composite particle comprises
inserting a rod-shaped magnet with a magnetic field strength of 100 mT to 1,000 mT into flooded soil after the reaction III, stirring, taking out the magnet after the mercapto group-loaded LDH-based magnetic composite particle is attracted by the magnet, and collecting attracted mercapto group-loaded LDH-based magnetic composite particle; and
washing collected mercapto group-loaded LDH-based magnetic composite particle with tap water and drying at a temperature of 50° C. to 100° C.; and
wherein regenerating recovered mercapto group-loaded LDH-based magnetic composite particle comprises
adding the recovered mercapto group-loaded LDH-based magnetic composite particle into a salt solution, and stirring or oscillating; and
withdrawing the mercapto group-loaded LDH-based magnetic composite particle, washing with water, and drying to obtain regenerated mercapto group-loaded LDH-based magnetic composite particle,
wherein the salt solution is selected from the group consisting of a MgCl₂ solution and a Na₂S₂O₃ solution;
a dosage of the recovered mercapto group-loaded LDH-based magnetic composite particle in the salt solution is in a range of 50 g/L to 200 g/L; and
the recovered mercapto group-loaded LDH-based magnetic composite particle is regenerated for 0.5 h to 4.0 h.
